(19) United States
(12) Patent Application Publication
(10) Pub. No.: US 2020/0217665 A1
(43) Pub. Date: Jul. 9, 2020

(54) MOBILE PLATFORM, IMAGE CAPTURE PATH GENERATION METHOD, PROGRAM, AND RECORDING MEDIUM

(71) Applicant: SZ DJI TECHNOLOGY CO., LTD., Shenzhen (CN)

(72) Inventors: Lei GU, Shenzhen (CN); Zhejun CHEN, Shenzhen (CN)

(21) Appl. No.: 16/818,617

(22) Filed: Mar. 13, 2020

Related U.S. Application Data
(63) Continuation of application No. PCT/CN2017/116542, filed on Dec. 15, 2017.

(30) Foreign Application Priority Data
Sep. 28, 2017 (JP) 2017-188023

(51) Int. Cl. G01C 21/20; G08G 5/00; B64C 39/02

(52) U.S. Cl. CPC G01C 21/20; G08G 5/0034; B64C 2201/14; B64C 2201/027; B64C 39/024

(57) ABSTRACT

A photo-imaging route generating method includes obtaining information on a photo-imaging range, generating a first photo-imaging route, the first photo-imaging route passing through a first photo-imaging position at which a first range of photographic images is captured within the photo-imaging range, calculating a first repeatability of the first range of photographic images obtained at the first photo-imaging position, when the first repeatability is below a threshold, generating a second photo-imaging position at which a second batch of photographic images is captured, and generating a second photo-imaging route, the second photo-imaging route passing through both the first photo-imaging position and the second photo-imaging position.

### CROSS-REFERENCE TO RELATED APPLICATIONS

This application is a continuation of International Application No. PCT/CN2017/116542, filed Dec. 15, 2017, which in turn claims the priority of JP 2017-188023, filed Sep. 28, 2017, the entire contents of both of which are incorporated herein by reference.

### TECHNICAL FIELD

The present disclosure relates to a movable platform used on a photo-imaging route for photo-imaging via a movable object, a photo-imaging route generation method, a program, and a storage medium.

### BACKGROUND

There are platforms (unmanned aerial vehicles) that perform imaging while passing along predetermined flight paths. The platform receives an imaging instruction from a ground base station and images the to-be-imaged object. When imaging the to-be-imaged object, the platform flies along the fixed path and causes an imaging equipment of the platform to be tilted for imaging according to a positional relationship between the platform and the to-be-imaged target.

### SUMMARY

In accordance with the disclosure, there is provided a method of generating photo-imaging route to be used on a movable platform via a movable object, the method including obtaining information on a photo-imaging range, generating a first photo-imaging route, the first photo-imaging route passing through a first photo-imaging position at which a first range of photographic images is captured within the photo-imaging range, calculating a first repeatability of the first range of photographic images obtained at the first photo-imaging position, when the first repeatability is below a threshold, generating a second photo-imaging position at which a second batch of photographic images is captured, and generating a second photo-imaging route, the second photo-imaging route passing through both the first photo-imaging position and the second photo-imaging position.

Also in accordance with the disclosure, there is provided a movable platform, the movable platform including a memory and a processor coupled to the memory, the processor being configured to perform obtaining information on a photo-imaging range, generating a first photo-imaging route, the first photo-imaging route passing through a first photo-imaging position at which a first range of photographic images is captured within the photo-imaging range, calculating a first repeatability of the first range of photographic images obtained at the first photo-imaging position, when the first repeatability is below a threshold, generating a second photo-imaging position at which a second batch of photographic images is captured, and generating a second photo-imaging route, the second photo-imaging route passing through both the first photo-imaging position and the second photo-imaging position.

### BRIEF DESCRIPTION OF THE DRAWINGS

FIG. 1 is a schematic structural diagram of an aerial photo-imaging route generation system according to an embodiment of the present disclosure.

FIG. 2 is a schematic structural diagram of an aerial photo-imaging route generation system according to another embodiment of the present disclosure.

FIG. 3 is a schematic block diagram of a hardware structure of the unmanned aerial vehicle according to yet another embodiment of the present disclosure.

FIG. 4 is a schematic block diagram of a hardware structure of a terminal according to yet another embodiment of the present disclosure.

FIG. 5 is a schematic diagram of an aerial photo-imaging range according to yet another embodiment of the present disclosure.

FIG. 6 is a schematic diagram of an aerial photo-imaging route AP12 passing through aerial photo-imaging position AP11 according to yet another embodiment of the present disclosure.

FIG. 7 is a schematic diagram showing repeatability of any position within an aerial photo-imaging range according to yet another embodiment of the present disclosure.

FIG. 8 is a schematic diagram of repeatability of each position within an aerial photo-imaging range according to yet another embodiment of the present disclosure.

FIG. 9 is a schematic diagram showing an inadequate area within an aerial photo-imaging range according to yet another embodiment of the present disclosure.

FIG. 10 is a schematic diagram showing an aerial photo-imaging position AP21 according to yet another embodiment of the present disclosure.

FIG. 11 is a schematic diagram of an aerial photo-imaging route AP22 passing through aerial photo-imaging positions AP11 and AP21 according to yet another embodiment of the present disclosure.

FIG. 12 is a schematic diagram flow chart of actions at a terminal when aerial photo-imaging route is generated at the terminal according to yet another embodiment of the present disclosure.

FIG. 13 is a schematic flow chart of actions of an unmanned aerial vehicle when aerial photo-imaging route is generated at the unmanned aerial vehicle according to yet another embodiment of the present disclosure.

### DETAILED DESCRIPTION OF THE EMBODIMENTS

Described herein relates to exemplary embodiments of the disclosure and does not limit the scope of any of the claims. Not all feature combinations referenced to in the exemplary embodiments are necessarily required for the solutions to the disclosure.

An exemplary apparatus may periodically obtain photographic images of the ground conditions while flying along a fixed route within a predetermined area.

Images may be taken in certain repeat rate according to the geographical range contained in these images. Accordingly, within the predetermined area, areas closer to the center of the predetermined area are more likely to be of a certain repeat rate. On the other hand, the repeatability may decrease at end portions of the predetermined area because no images are taken outside of the predetermined area. Accordingly, repeatability of the captured images is not maintained as being dependent on locations within the predetermined area, even when images are taken in equal divisions within the predetermined area. Under these circumstances, image quality of a composite image generated according to multiple images may decrease. Moreover, image quality of a stereoscopic image formed from multiple photographic images, for example, may also decrease.

Furthermore, and to achieve certain repeatability at end portions of the predetermined area, images may be taken in an area generally bigger than the predetermined area, and therefore excess images may be taken to ensure certain repeatability. Accordingly, some images may be useless, and image efficiency may decrease.

In the embodiments to follow, disclosure is made in general to an unmanned aerial vehicle (UAV) as a movable platform. Unmanned aerial vehicle is an example of a flying body, including flying objects in the air. Flying bodies are a type of movable bodies. Drawings described in this disclosure are directed to the unmanned aerial vehicles as UAV. In addition, the movable platform may be a device other than the unmanned aerial vehicle, such as a terminal, a personal computer (PC), or other devices. The photo-imaging route generating method describes actions associated with the movable platform. The recording medium includes a program, such as a program configured for the movable platform to execute different kinds of processes.

### First Embodiment

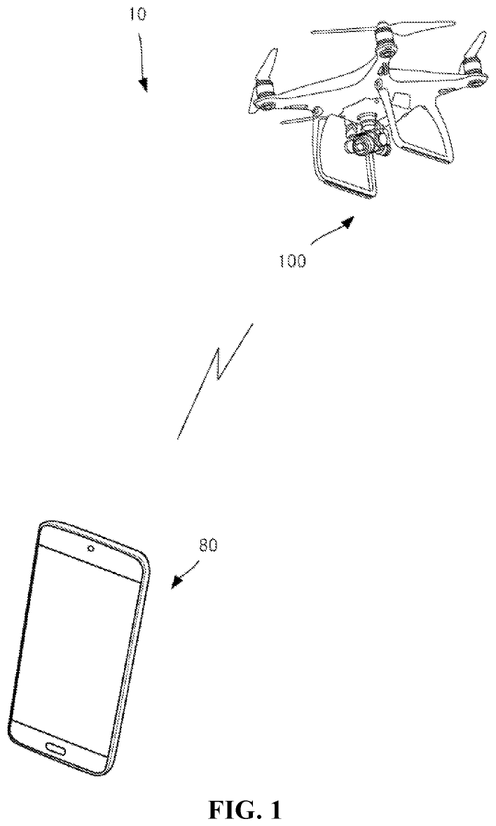

FIG. 1 is a schematic structural diagram of an aerial photo-imaging route generating system 10 according to a first embodiment. The aerial photo-imaging generating system 10 includes an unmanned aerial vehicle 100 and a terminal 80. The unmanned aerial vehicle 100 and the terminal 80 may communicate with each other via wired connection or wireless connection, such as LAN (Local Area Network). As schematically shown in FIG. 1, the terminal 80 is a portable terminal, such as a smart phone or a terminal.

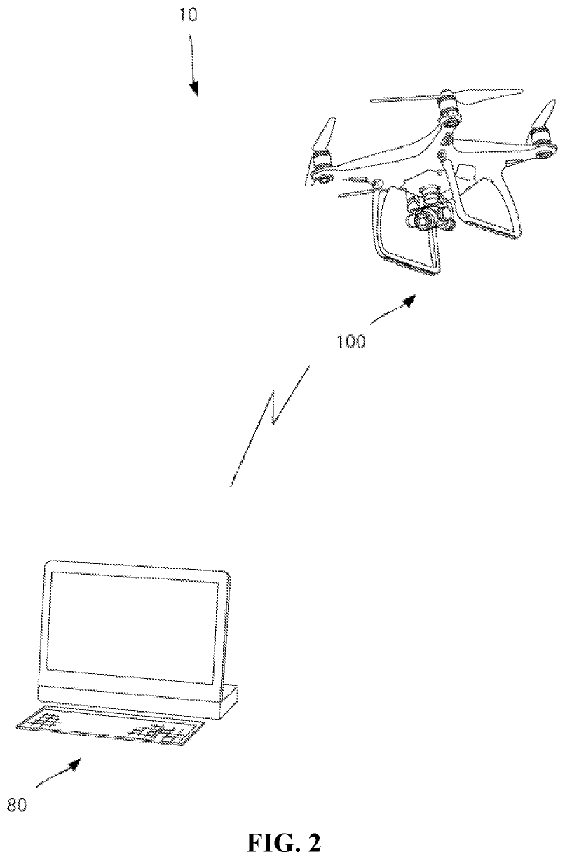

FIG. 2 is a schematic structural diagram of an aerial photo-imaging route generating system 10 according to a second example of the first embodiment. As schematically shown in FIG. 2, the terminal 80 is a personal computer. As schematically shown in FIG. 1 and FIG. 2, the terminal 80 may be of same function.

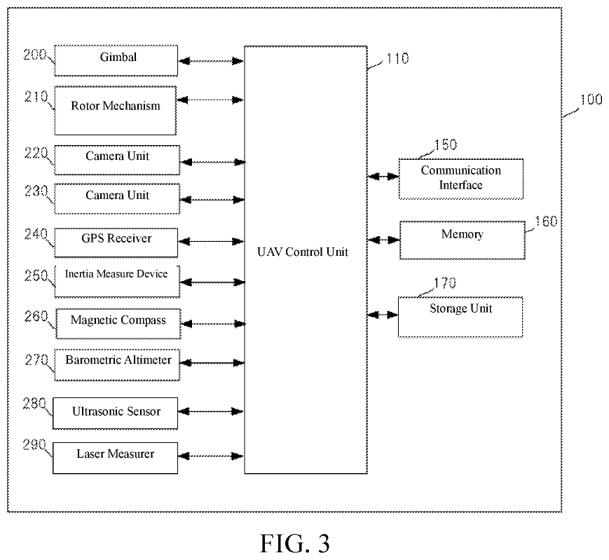

FIG. 3 is a schematic block diagram of a hardware structure of an unmanned aerial vehicle 100. The unmanned aerial vehicle 100 includes a UAV control unit 110, a communication interface 150, a memory 160, a storage unit 170, a gimbal 200, a rotor mechanism 210, a photographic imaging unit 220, a photographic imaging unit 230, a GPS receiver 240, an inertia measurement unit 250, a magnetic compass 260, a barometric altimeter 270, an ultrasonic sensor 280, and a laser measuring unit 290.

The UAV control unit 110 includes, for example, a central processing unit (CPU), a micro processing unit (MPU), or a digital signal processor (DSP). The UAV control unit 110 in general processes signals of actions by each part of the unmanned aerial vehicle 100, and processes data input and output, data calculation and data storage in communications with other units.

According to the program stored in the memory 160, the UAV control unit 110 controls flying of the unmanned aerial vehicle 100. The UAV control unit 110 may control flying via the aerial photo-imaging route generated according to the terminal 80 or the unmanned aerial vehicle 100. The UAV control unit 110 may conduct aerial photo-imaging of images at aerial photo-imaging positions generated according to the terminal 80 or the unmanned aerial vehicle 100.

The UAV control unit 110 obtains position information of the unmanned aerial vehicle 100. The UAV control unit 110 obtains information on the latitude, longitude and altitude of the position of the unmanned aerial vehicle 100. The UAV control unit 110 may obtain information on the latitude, longitude and altitude of the position of the unmanned aerial vehicle 100 from the GPS receiver 240, and obtain the altitude information of the position of the unmanned aerial vehicle 100 from the barometric altimeter 270 and regards the altitude information as the position information. The UAV control unit 110 may obtain a distance between an ultrasonic emission point and an ultrasonic reflection point from the ultrasonic sensor 280, and regards the distance as the altitude information.

The UAV control unit 110 may obtain direction information on a direction of the unmanned aerial vehicle 100 from the magnetic compass 260. The direction information may be represented by the direction of the head portion of the unmanned aerial vehicle 100.

The UAV control unit 110 may obtain position information on where the unmanned aerial vehicle 100 may be located when the camera unit 220 conducts photo-imaging within a photo-imaging range. The UAV control unit 110 may obtain position information on where the unmanned aerial vehicle 100 may be located from other devices via the communication interface 150. The UAV control unit 110 may detect a possible location of the unmanned aerial vehicle 100 according to a three-dimensional map database and regards this locations as where the unmanned aerial vehicle 100 may be located.

The UAV control unit 110 may obtain photo-imaging range information from photo-imaging ranges respectively from the camera unit 220 and the camera unit 230. The UAV control unit 110 may obtain information showing photo-imaging direction of the camera unit 220 and the camera unit 230. The UAV control unit 110 may obtain posture information of a posture state of the cameral unit 220 from the gimbal 200, such as information of a photo-imaging direction of the camera unit 220. The posture information of the camera unit 220 may show the angle at which the pitch axis and the yaw axis of the gimbal 200 rotate from a reference rotation angle.

The UAV control unit 110 may obtain position information of the unmanned aerial vehicle 100, as a parameter to determine a photo-imaging range. The UAV control unit 110 may determine a photo-imaging range of a geographical area on which the camera unit 220 conducts photo-imaging, generates information on photo-imaging range, and to obtain information on the photo-imaging range, according to a viewing angle and a photo-imaging direction of the camera unit 220 and the camera unit 230, and according to the location of the unmanned aerial vehicle 100.

The UAV control unit 110 may obtain photo-imaging range information from the memory 160. The UAV control unit may obtain photo-imaging range information from the communication interface 150.

The UAV control unit 110 controls the gimbal 200, the rotor mechanism 210, the camera unit 220 and the camera unit 230. The UAV control unit 110 may control the photo-imaging range of the camera unit 220 via changing the photo-imaging direction or angle of the camera unit 220.

The photo-imaging range refers to a geographical range that is photographed by the camera unit 220 or the camera unit 230. The photo-imaging range is defined by latitude, longitude, and altitude. The photo-imaging range may be a range of three-dimensional data defined with a latitude, a longitude, and an altitude. The photo-imaging range may also be a range of two-dimensional data defined with a latitude and a longitude. The photo-imaging range may be determined according to the viewing angle and the photo-imaging direction of the camera unit 220 or the camera unit 230, and according to the location of the unmanned aerial vehicle 100. The photo-imaging direction of the camera unit 220 and the camera unit 230 may be defined according to direction and angle of the camera lens of the camera unit 220 and the camera unit 230. A photo-imaging direction of the camera unit 220 may be a direction determined according to a position of the head portion of the unmanned aerial vehicle 100, and according to a posture status of the cameral unit 220 relative to the gimbal 200. The photo-imaging direction of the camera unit 230 may be a direction determined according to a position of the head portion of the unmanned aerial vehicle 100 and a position set by the camera unit 230.

The UAV control unit 110 may analyze multiple images captured via multiple camera units 230 and then identify the environment surrounding the unmanned aerial vehicle 100. The UAW control unit 110 may control flying according to the environment surrounding the unmanned aerial vehicle 100, to avoid obstacles.

The UAV control may obtain stereoscopic information (three-dimensional information) of a stereoscopic structure (three-dimensional structure) of an object present at a peripheral of the unmanned aerial vehicle 100. The object may be a part of a scene such as a building, a road, a vehicle, and a tree. The stereoscopic information includes three-dimensional data. The UAV control unit 110 may generate stereoscopic information of the stereoscopic structure of the object present at a peripheral of the unmanned aerial vehicle 100 from images obtained via multiple camera units 230, to obtain the stereoscopic information. The UAV control unit 110 may obtain the stereoscopic information of the stereoscopic structure of the object present at the peripheral of the unmanned aerial vehicle 100 according to the three-dimensional map database stored in the memory 160 or the storage unit 170. The UAV control unit 110 may obtain the stereoscopic information related to the stereoscopic shape of the object present at a peripheral of the unmanned aerial vehicle 100 according to the three-dimensional map database managed by online servers.

The UAV control unit 110 controls flying of the unmanned aerial vehicle 100 via controlling rotor mechanism 210. In particular, the UAV control unit 110 control the position of the unmanned aerial vehicle 100 via controlling the rotor mechanism 210, where the position includes position regarding latitude, longitude, and altitude. The UAV control unit 110 controls a photo-imaging range of the camera unit 220 via controlling flying of the unmanned aerial vehicle 100. The UAV control unit 110 controls a viewing angle of the camera unit 220 via controlling a zoomable lens of the camera unit 220. The UAV control unit 110 may control a viewing angle of the camera unit 220 via digital zooming function of the camera unit 220.

When the camera unit 220 is fixated onto the unmanned aerial vehicle 100 to prevent the camera unit 220 from moving, the UAV control unit 110 may move the unmanned aerial vehicle 100 in certain time such that the camera 220 may photo-image within a photo-imaging range desirable under certain circumstances. Alternatively, and when the cameral unit 220 is not zoomable and does not change in viewing angle, the UAV control unit 110 may cause the unmanned aerial vehicle 100 to move to a certain position at a certain time, to enable the camera unit 220 to capture images within a desirable photo-imaging range and under a desirable environment.

The communication interface 150 communicates with the terminal 80. The communication interface 150 may communicate via any wireless communication methods. The communication interface 150 may communicate via any wired communication methods. The communication interface 150 may send to the terminal 80 aerial photographic images or supplemental information (metadata) related to the aerial photographic images.

The memory 160 stores a program useful for the UAV control unit 110 to control the gimbal 200, the rotor mechanism 210, the camera unit 220, the camera unit 230, the GPS receiver 240, the inertia measurement device 250, the magnetic compass 260, the barometric altimeter 270, the ultrasonic sensor 280, and the laser detector 290. The memory 160 may be computer readable medium, including at least one of static random access memory (SRAM), dynamic random access memory (DRAM), erasable programmable read only memory (EPROM), electrically erasable programmable read-only memory (EEPROM), and universal serial bus (USB). The memory 160 may be detached from the unmanned aerial vehicle 100. The memory 160 may work as a working memory.

The storage unit 170 may include at least one of a Hard Disk Drive (HDD), a Solid State Drive (SSD), a SD card, a USB drive, or other storage drives. The storage unit 170 may be detached from the unmanned aerial vehicle 100. The storage unit 170 may record aerial photographic images.

The memory 160 or the storage unit 170 may store information of aerial photo-imaging position or aerial photo-imaging route generated via the terminal 80 or the unmanned aerial vehicle 100. As one of aerial photo-imaging parameter predetermined by the unmanned aerial vehicle 100 or a flying parameter predetermined by the unmanned aerial vehicle 100, the aerial photo-imaging position or the aerial photo-imaging route information may be set by the UAV control unit 110. The setting information may be stored in the memory 160 or the storage unit 170. The flying parameter may be an example of a movement parameter.

The gimbal 200 provides support to the camera unit 220 by causing the camera unit 220 to be rotatable about a yaw axis, a pitch axis, and a roll axis. The gimbal 200 may change a photo-imaging direction of the camera unit 220 by causing the camera unit 220 to rotate about at least one of the yaw axis, the pitch axis, or the roll axis.

The yaw axis, the pitch axis, and the roll axis may be determined as follows. For example, the roll axis is defined along a horizontal direction, such as a direction parallel to the ground. Under this setting, the pitch axis is defined as a direction parallel to the ground and perpendicular to the roll axis, and the yaw axis (referred to as a “z” axis) is defined as a direction perpendicular to the ground and perpendicular to the pitch axis and the roll axis.

The rotor mechanism 210 includes multiple rotors and drive motors which cause the rotors to rotate. The rotor mechanism 210 causes the unmanned aerial vehicle 100 to fly by making the UAV control unit 110 to control rotation. The rotors 211 may be of a number of 4, or may be of a different number. In addition, the unmanned aerial vehicle 100 may be a rotorless fixed-wing aircraft.

The camera unit 220 is a photo-imaging camera employed to capture photographic images of to-be-imaged objects contained in the anticipated photo-imaging range, such as scenes over the sky above to-be-images objects, mountains or waters, and structures on the ground. The cameral unit 220 generates data of the photographic images captured from the to-be-imaged objects contained within the anticipated photo-imaging range. Image data obtained via the camera unit 220, such as aerial photo-imaging, may be stored in the memory or storage unit 170 of the cameral unit 220.

The camera unit 230 may be a sensor camera for capturing images in the peripherals of the unmanned aerial vehicle 100 to control flying of the unmanned aerial vehicle 100. The 2 camera units 230 may be positioned in a front head portion of the unmanned aerial vehicle 100. Moreover, another 2 camera units 230 may be positioned at a bottom of the unmanned aerial vehicle 100. The 2 camera units 230 in the front head portion may be paired to function as a stereoscopic camera. The 2 camera units 230 in the bottom may also be paired to function as a stereoscopic camera. Images captured by a plurality of camera units 230 may be used to generate three-dimensional data such as three-dimensional structural data about the peripherals of the unmanned aerial vehicle 100. The camera units 230 of the unmanned aerial vehicle 100 are not limited to a number of 4. The unmanned aerial vehicle 100 may include at least 1 camera unit 230. The unmanned aerial vehicle 100 may include at least 1 camera unit 230 respectively positioned at the front head portion, the tail portion, the side portion, the bottom portion, and the top portion. A viewing angle of the camera unit 230 may be bigger than a viewing angle of the camera unit 220. The camera unit 230 may include a fixed focus lens or a fisheye lens. The camera unit 230 photo-images the peripherals of the unmanned aerial vehicle 230 to generate data on the images as captured. The images captured by the camera unit 230 may be stored in the storage unit 170.

GPS receiver 240 receives multiple signals from multiple navigation satellites, or GPS satellites, where the signals represent time and position of each of the GPS satellites. The GPS receiver 240 calculates the position of the GPS receiver 240, or the position of the unmanned aerial vehicle 100, according to the multiple signals as received. The GPS receiver 240 sends the position information of the unmanned aerial vehicle 100 out to the UAV control unit 110. Additionally, the UAV control unit 110 may, in replacement of the GPS receiver 240, calculate the position information of the GPS receiver 240. Accordingly, information showing time and position of each of the GPS satellites and contained within the multiple signals from the GPS receiver 240 may be outputted to the UAV control unit 110.

The inertia measurement device 250 detects a posture of the unmanned aerial vehicle 100 and sends the detection results to the UAV control unit 110. The inertia measurement device 250 detects an acceleration speed of the unmanned aerial vehicle 100 along 3 axial directions, namely front and back, left and right, and above and below, and detects an angular speed along 3 axial directions, namely a pitch axis, a roll axis, and a yaw axis, as posture of the unmanned aerial vehicle 100.

The magnetic compass 260 detects a direction of the head portion of the unmanned aerial vehicle 100 and sends the detected results to the UAV control unit 110.

The barometric altimeter 270 detects a flying altitude of the unmanned aerial vehicle 100, and sends the detected results to the UAV control unit 110.

The ultrasonic sensor 280 emits ultrasound, detects the ultrasound reflected from the ground or an object, and sends the detected results to the UAV control unit 110. The detected results may represent a distance of the unmanned aerial vehicle 100 away from the ground, or the altitude of the unmanned aerial vehicle 100. The detected results represent a distance of the unmanned aerial vehicle 100 away from an object, or a to-be-imaged object.

The laser detector 290 emits laser light to the object, receives light reflected from the object, and determines the distance between the unmanned aerial vehicle 100 and the to-be-imaged object according to the light reflected. For example, time of flight may be used as a way to detect distance via laser light.

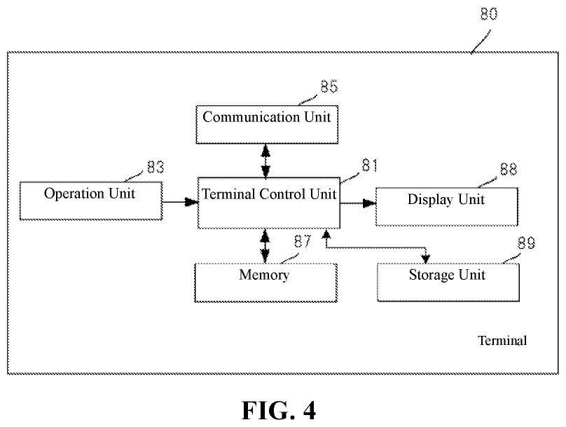

FIG. 4 is a schematic diagram showing a hardware structure of the terminal 80. The terminal 80 may include a terminal control unit 81, an operation unit 83, a communication unit 85, a memory 87, a display unit 88 and a storage unit 89. The terminal 80 may be in possession by a user who wishes to generate an aerial photo-imaging route.

The terminal control unit 81 uses structures such as CPU, MPU or DSP. The terminal control unit 81 conducts signal processing on actions of different units of the terminal 80, conducts processing on data transport, data calculation, and data storage, in connection with other units.

The terminal control unit 81 may obtain images or information from the unmanned aerial vehicle 100 via the communication unit 85. The terminal control unit 81 may obtain data or information, such as a variety of parameters, sent through the operation unit 83. The terminal control unit 81 may obtain data stored inside of the storage 87 and images and information captured via aerial photo-imaging. The terminal control unit 81 may send data or information, such as information on position and route of aerial photo-imaging, to the unmanned aerial vehicle 100 via the communication unit 85. The terminal control unit 81 may send data, information or images captured by aerial photo-imaging to the display unit 88, and to cause the data, the information, and the images as captured to be displayed at the display unit 88.

The terminal control unit 81 executes applications useful in generating aerial photo-imaging routes or in helping generate the aerial photo-imaging routes. The terminal control unit 81 may generate many kinds of data useful in the applications.

The operation unit 83 receives and obtains data or information inputted by a user at the terminal 80. The operation unit 83 may include a button, a switch, a touch panel, or a microphone. Here is shown, as an example, the operation unit 83 and the display unit 88 configured as a touch panel. Under these circumstances, the operation unit 83 may receive, for example, a touch operation, a trigger operation, and a drag operation. The operation unit 83 may receive information on many kinds of parameters. The information inputted via the operation unit 83 may be sent to the unmanned aerial vehicle 100. The parameters may include parameters related to the aerial photo-imaging route, such as information on at least one of the threshold th of repeatability, a flying parameter, or a photo-imaging parameter of the unmanned aerial vehicle 100 flying along the aerial photo-imaging route.

The communication unit 85 communicates wirelessly with the unmanned aerial vehicle 100 via wireless communication methods. Such wireless communication methods include wireless LAN, Bluetooth (registered mark) or public wireless line communications. The communication unit 85 may conduct wired communication via any suitable wired communication methods.

The memory 87 includes ROM that stores programs or predetermined values defining actions of the terminal 80, and RAM that is temporarily stored in the terminal control unit 81 and useful for processing a variety of information and data. The memory 87 may include memory other than ROM and RAM. The memory 87 may be positioned inside of the terminal 80. The memory 87 may be configured to be removable from the terminal 80. The program includes applicable programs or applications.

The display unit 88 includes for example a liquid crystal display (LCD), to display a variety of information, data, or aerial photographic images outputted from the terminal control unit 81. The display unit 88 may display a variety of data and information associated with execution of applications.

The storage unit 89 stores a variety of data and information. The storage unit 89 may be an HDD, SSD, an SD card, or a USB storage. The storage unit 89 may be positioned inside of the terminal 80. The storage unit 89 may be configured to be removable from the terminal 80. The storage unit 89 may store aerial photographic images or supplemental information obtained from the unmanned aerial vehicle 100. The supplemental information may be stored in the memory 87.

Next, description is made to the aerial photo-imaging route regarding its functions. Here, description is mainly provided to describe functions of the terminal control unit 81 of the terminal 80 that are related to the aerial photo-imaging route, or functions of the unmanned aerial vehicle 100 that are related to the aerial photo-imaging route. The terminal control unit 81 may be an example of the control unit. The terminal control unit 81 conducts processing related to generation of the aerial photo-imaging routes.

The terminal control unit 81 obtains the aerial photo-imaging range A1. The photo-imaging range A1 includes a range directed to by the unmanned aerial vehicle 100 in photo-imaging. Within the photo-imaging range A1, the goal is to locate positions within the photo-imaging range A1 where the image range GH at each of these positions is of a repeatability greater than the threshold th. In other words, certain repeatability OV is maintained within the aerial photo-imaging range A1. Moreover, the repeatability OV is in certain corresponding relationship with the repeatability of multiple image ranges GH. For example, when the repeatability OV is greater than the threshold th, the repeat rate is then considered above a predetermined value.

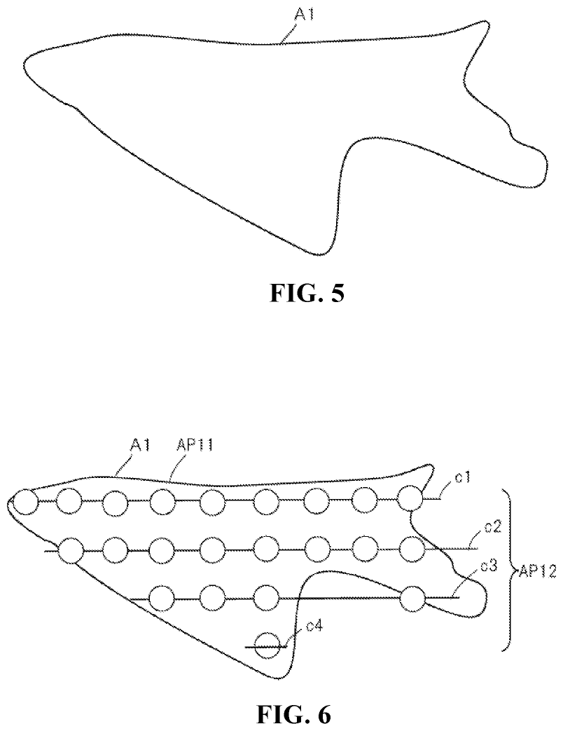

FIG. 5 is a schematic diagram showing the aerial photo-imaging range A1. The terminal control unit 81 may obtain the aerial photo-imaging range A1 from the memory 87. The terminal control unit 81 may obtain the aerial photo-imaging range from the memory 87 or an external server. The terminal control unit 81 may obtain the aerial photo-imaging range A1 from the operation unit 83. The operation unit 83 may receive a user input on a desirable range of the aerial photo-imaging as shown in the map information retrievable from the map database and regards the user input as the aerial photo-imaging range A1. In addition, the operation unit 83 may input a desirable location name, a building name that can distinguish a location, and other names as objects for the aerial photo-imaging. Under these circumstances, the terminal control unit 81 may obtain the aerial photo-imaging range A1 as shown in the range directed to by the location name, and may obtain the aerial photo-imaging range A1 according to predetermined range of a peripheral to a location name, such as a range within 100 meters in radius from a center of a position shown by the location name.

The terminal control unit 81 generates the aerial photo-imaging route AP12 that passes through the aerial photo-imaging position AP11 located within the aerial photo-imaging range. The aerial photo-imaging route AP12 may be generated via a suitable method. The aerial photo-imaging position AP11 may also be generated via a suitable method. The aerial photo-imaging positions AP11 may be located with equal distances therebetween on the aerial photo-imaging route AP12. Alternatively, the aerial photo-imaging positions AP11 may be located with unequal or different distances therebetween. The aerial photo-imaging position AP11 is an example of the first photo-imaging position. The aerial photo-imaging route AP12 is an example of the first photo-imaging route.

FIG. 6 is a schematic example diagram of an aerial photo-imaging route AP12 that passes through the aerial photo-imaging position AP11. In FIG. 6, the aerial photo-imaging route AP12 includes 4 linear lines, namely aerial photo-imaging lines c1, c2, c3, and c4. In FIG. 6, aerial photo-imaging position AP11 is located inside of the aerial photo-imaging range A1 and respectively on the aerial photo-imaging lines c1, c2, c3, and c4. In FIG. 6, the aerial photo-imaging position AP11 as located on each of the aerial photo-imaging lines c1 through c4 may differ according to the aerial photo-imaging range A1. The aerial photo-imaging lines c1 through c4 may connected to one and another in turn, to form the aerial photo-imaging route AP12. In comparison to aerial photo-imaging lines c1 and c2, aerial photo-imaging lines c3 and c4 present fewer aerial photo-imaging positions AP11. Although the aerial photo-imaging line c4 is shown in a straight line in FIG. 6 extending between left and right, the aerial photo-imaging line c4 may also extend in a different direction, such as a direction extending between positions above and below FIG. 6.

According to each position contained within the aerial photo-imaging range A1, the terminal control unit 81 calculates a level of repeat, or repeatability, of photo-imaging range of images captured via aerial photo-imaging at the aerial photo-imaging position AP11 via the camera unit 220 or the camera unit 230 of the unmanned aerial vehicle 100. The repeatability OV may be represented by a number of aerial photographic images (number of repeats) of the photo-imaging range GH at each position within the aerial photo-imaging range A1. The terminal control unit 81 may reflect the repeatability at each position on a two-dimensional plane, and generate a repeatability map OM. The terminal control unit 81 may make repeatability OV visible by displaying the repeatability map OM via the display unit 88. The terminal 80 enables for a user a visual representation of a distribution of the repeatability OV of each of the positions within the aerial photo-imaging range A1, via displaying the repeatability distribution map OM.

The image range GH of the aerial photographic images obtained via photo-imaging by the unmanned aerial vehicle 100 corresponds to the geographical range of the aerial photographic images. Image ranges GH of multiple aerial photo-imaging may be a repeat to one and another. For example, when 2 image ranges GH of aerial photographic images are a repeat to each other, at the position where the 2 image ranges GH of aerial photographic images repeat, the number of repeats of the aerial photographic images is 2. In other words, 2 aerial photographic images are captured at this particular position. Similarly, when 3 image ranges are obtained at a position within the aerial photo-imaging range A1, the number of repeats of the aerial photographic images is 3. In other words, 3 aerial photographic images are captured at this particular location. The number of repeats in the photo-imaging range of the aerial photographic images is an example of the aerial photo-imaging repeatability OV.

The image range GH may be determined according to flying parameters of the unmanned aerial vehicle 100 in a future trip, and according to photo-imaging parameters of the camera unit 220 or the camera unit 230 of the unmanned aerial vehicle 100. The flying parameters may include at least one of aerial photo-imaging position information, aerial photo-imaging route information, or aerial photo-imaging timing information. The photo-imaging parameters may include at least one of viewing angle information of aerial photo-imaging, direction information of aerial photo-imaging, posture information of aerial photo-imaging, photo-imaging range information, or distance information on the to-be-images object, and other information such as resolution, image range, and repeatability.

The aerial photo-imaging route information represents a predetermined route, or aerial photo-imaging route, of aerial photographic images. The aerial photo-imaging route information is information on a flying route of the unmanned aerial vehicle 100 while conducting the photo-imaging, and the route may be aerial photo-imaging route AP12. The aerial photo-imaging position information is directed to a predetermined position of aerial photographic images during aerial photo-imaging, where the position may be a three-dimension position defined by a latitude, a longitude, and an altitude, such as the aerial photo-imaging position AP11. The aerial photo-imaging timing information refers to a predetermined timing such as aerial photo-imaging timing of aerial photographic images during aerial photo-imaging.

The aerial photo-imaging viewing angle information refers to information on the field of view of a viewing angle of the cameral unit 220 or the camera unit 230 during aerial photo-imaging. The aerial photo-imaging posture information refers to a posture of the camera unit 220 or the camera unit 230 during aerial photo-imaging. The image range information refers to an image range of the camera unit 220 or the camera unit 230, such as rotational angle about the gimbal 200, during aerial photo-imaging. The distance information of the to-be-imaged object refers to information on a distance between the to-be-imaged object and the cameral unit 220 or the camera unit 230 during aerial photo-imaging.

In addition, the flying parameters and photo-imaging parameters are not parameters of aerial photo-imaging in the past, but instead predetermined parameters of aerial photo-imaging planed in the future. The predetermined parameters for future aerial photo-imaging may be the same to parameters of past aerial photo-imaging.

The terminal control unit 81 may determine the image range GH of multiple aerial photographic images according to at least one of the photo-imaging parameters or the flying parameters. For example, the terminal control unit 81 may calculate out the image range GH according to at least one of the viewing angle FOV, aerial photo-imaging angle, posture of the camera unit 220, or aerial photo-imaging position (as defined by latitude, longitude, and altitude).

For example, equation (1) may be used to show relationship among aerial photo-imaging distance gap “d”, aerial photo-imaging distance “L”, viewing angle FOV of the camera unit 220 or the camera unit 230 during aerial photo-imaging, and repeat rate “or” of the image range GH of aerial photographic images.

d=L*FOV*(1−or) (1)

As used in Equation (1), sign “*” represents multiplication symbol. The aerial photo-imaging distance gap “d” may be a predetermined value, for example as a distance between 2 aerial photo-imaging positions AP11. The aerial photo-imaging distance “L” represents a distance between the unmanned aerial vehicle 100 while conducting aerial photo-imaging and the to-be-imaged object, such as the ground surface, and the distance “L” may be the flying altitude. The repeat rate “OR” represents a ratio of repeatability of two adjacent image ranges GH of aerial photographic images.

Equation (2) sets out additional relationship between the aerial photo-imaging distance “d”, the aerial photo-imaging repeat rate “or”, width “w” of the image range GH of aerial photographic images, and resolution “r” of aerial photographic images OG.

d=r*w*(1−or) (2)

The operation unit 83 at the terminal 80 may receive at least one of photo-imaging parameters or flying parameters inputted by a user. For example, the operation unit 83 may input at least a portion of the parameters contained in the equation (1) and equation (2).

The terminal control unit 81 may calculate a width w (such as the length of a side of a rectangle) of the image range GH according to equations (1) and (2). In addition, the terminal control unit 81 may obtain a two-dimensional position, for example defined by latitude and longitude, of the aerial photo-imaging position AP11. Accordingly, the terminal control unit 81 may determine a geographical range embraced by the image range GH during photo-imaging toward the ground surface by the camera unit 220 or camera unit 230 of the unmanned aerial vehicle 100, according to the width of the image range GH and according to the two-dimensional position of the aerial photo-imaging position AP11. Therefore, repeatability of the image range GH of the aerial photo-imaging range may be calculated according to each position contained within the aerial photo-imaging range A1.

Accordingly, the terminal 80 may calculate the repeatability OV according to the multiple aerial photo-imaging positions AP11 and according to the flying parameters and the photo-imaging parameters during photo-imaging at the aerial photo-imaging positions AP11, and thus avoid the need of having photo-imaging conducted while the unmanned aerial vehicle 100 is in actual flying session or having the camera unit 220 or the camera unit 230 conduct the photo-imaging. Repeatability OV may be readily obtained via the use of a single device and according to the flying parameters and photo-imaging parameters. In particular, the terminal control unit 81 may extract image range GH according to the flying parameters and the photo-imaging parameters, and calculate out repeatability OV according to relationship among multiple image ranges GH. The relationship among the multiple image ranges GH may be determined according to the location relationship among multiple aerial photo-imaging positions AP11 during aerial photo-imaging.

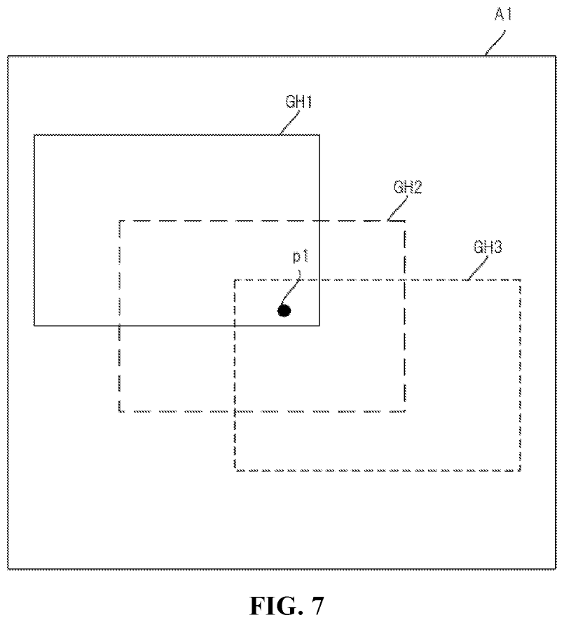

FIG. 7 schematically shows repeatability OV of position p1 within the aerial photo-imaging range A1. In FIG. 7, the position p1 is contained within 3 image ranges GH1, GH2, and GH3, and therefore the number of repeats is 3 for the position p1. In FIG. 7, repeatability OV is represented by the number of repeat images, and the repeating images may be suitably processed, such as imposing weight, to generate repeatability OV. FIG. 7 schematically shows repeatability OV at position p1; and repeatability of positions within the aerial photo-imaging range A1 other than the position p1 may also be schematically shown.

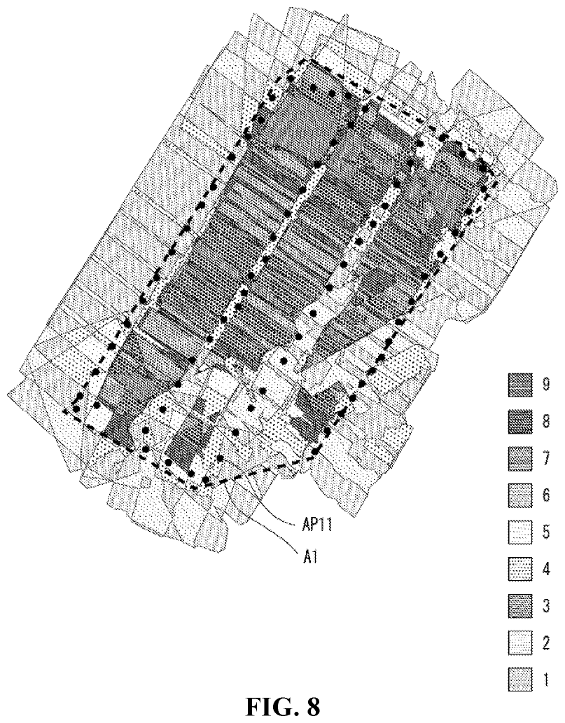

FIG. 8 schematically shows repeatability OV at each position within the aerial photo-imaging range A1, and is a schematic example diagram of the repeatability distribution map OM. In FIG. 8, repeatability OV is shown at each position, such as 1 repeat, 2 repeats, 3 repeats, 4 repeats, 5 repeats, 6 repeats, 7 repeats, 8 repeats, and 9 repeats. Repeatability may be greater than 9 repeats. In FIG. 8, when a peripheral portion of the aerial photo-imaging range A1 is compared to a central portion of the aerial photo-imaging range A1, there is a trend of repeatability getting smaller in value.

Accordingly, the terminal 80 enables for a user a visualization on distribution of the repeatability at each position of the aerial photo-imaging range A1, via displaying the repeatability distribution map OM. Under these circumstances, the user may enter an input via the operation unit 83 to place aerial photo-imaging position AP21 near a location, such as a location within the inadequate area LA, where the repeatability OV is insufficient. Under these circumstances, insufficient repeatability OV may be alleviated. Accordingly, the repeatability distribution map OM may be used to supplement placement of aerial photo-imaging position AP21.

The terminal control unit 81 extracts the inadequate area LA. The inadequate area LA is an area within the aerial photo-imaging range A1, the area including at least one position at which the repeatability (such as in a number of repeats) is below the threshold th (such as a repeat of 4). In other words, positions located within the inadequate area LA are of relatively lower repeatability in comparison to positions located elsewhere in the aerial photo-imaging range A1. The inadequate area LA is more likely to be present at a peripheral portion than at a central portion of the aerial photo-imaging range A1. An inadequate area LA may also appear at or near a central portion of the aerial photo-imaging range A1, according to the aerial photo-imaging route AP12 or the aerial photo-imaging position AP11.

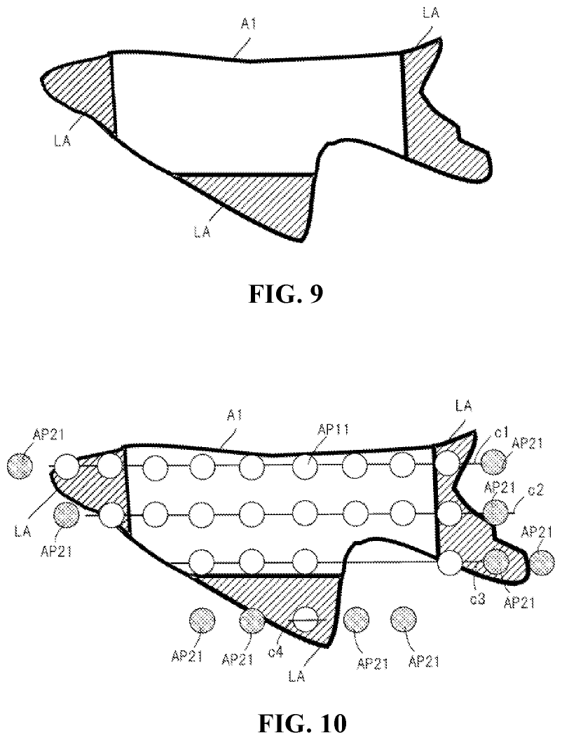

FIG. 9 is a schematic diagram showing an inadequate area LA. In FIG. 9, the inadequate area LA is present at 3 end portions of the aerial photo-imaging ranch A1.

When positions of which repeatability OV is below the threshold th are present in the aerial photo-imaging range A1, the terminal control unit 81 may generate and configure aerial photo-imaging position AP21. The aerial photo-imaging position AP21 is an aerial photo-imaging position to supplement photo-imaging of the aerial photo-imaging range A1. For example, the terminal control unit 81 may generate and configure aerial photo-imaging position AP21 according to a position of the inadequate area LA. The aerial photo-imaging position AP21 may be configured to be spaced apart in same distance from other aerial photo-imaging positions, for example, from a plurality of aerial photo-imaging positions AP11, and may also be configured to be spaced apart in different distance from other aerial photo-imaging positions. The aerial photo-imaging position AP21 is an example of the second photo-imaging position.

FIG. 10 is a schematic diagram showing an example configuration of the aerial photo-imaging position AP21. In FIG. 10, the aerial photo-imaging position AP21 is located inside of or near the inadequate area LA.

In general, along the aerial photo-imaging line c1, aerial photo-imaging positions AP11 at two ends of the aerial photo-imaging line c1 are located inside of the inadequate area LA, and therefore, 2 aerial photo-imaging position AP21 are respectively placed external to 2 aerial photo-imaging positions AP11 at ends of the aerial photo-imaging line c1. Similarly, along the aerial photo-imaging line c2, aerial photo-imaging positions AP11 at two ends of the aerial photo-imaging line c2 are located inside of the inadequate area LA, and therefore, 2 aerial photo-imaging position AP21 are respectively placed external to 2 aerial photo-imaging positions AP11 at ends of the aerial photo-imaging line c2. Accordingly, repeatability OV (OV1) of the photo-imaging range GH of an aerial photographic image that may be captured by the aerial photo-imaging line c1 and c2 is increased. Moreover, repeatability OV1 greater than the threshold th may be obtained, and user-desirable repeatability OV1 may be obtained via the aerial photo-imaging lines c1 and c2.

On the aerial photo-imaging line c3, one end of the aerial photo-imaging line c3, a right end as shown in FIG. 10, is located inside of the inadequate area LA. 2 aerial photo-imaging positions AP21 may be placed external to the aerial photo-imaging position AP11 at the end of the aerial-imaging line c3. Under these circumstances, repeatability OV1 of the image range GH reachable via aerial photo-imaging along the aerial photo-imaging line c3 is increased, and repeatability OV1 is improved at the terminal 80. In addition, multiple aerial photo-imaging positions AP21 may be placed external to the aerial photo-imaging position AP11 at the end of the aerial photo-imaging line c3. Accordingly, repeatability OV1 greater than the threshold th may be obtained, and user-desirable repeatability OV1 may be obtained along the aerial photo-imaging line c3.

On the aerial photo-imaging line c4, an aerial photo-imaging position AP11 on the aerial photo-imaging line c4 is located within the inadequate area LA, and 2 aerial photo-imaging positions AP21 may be placed respectively at both sides of the aerial photo-imaging position AP11. In addition, on the aerial photo-imaging line c4, via placing an aerial photo-imaging position AP21 at the at least one side of the aerial photo-imaging position AP11, repeatability OV1 of the image range GH of aerial photographic images along the aerial photo-imaging line c4 may be increased. Under these circumstances, the terminal 80 also improves the repeatability OV1. Furthermore, by placing 2 aerial photo-imaging positions AP21 respectively at both sides of the aerial photo-imaging position AP11, repeatability OV1 greater than the threshold th may be obtained, and user-desirable repeatability OV1 may be obtained along the aerial photo-imaging line c4.

The terminal control unit 81 may conduct the following process to ascertain the configuration position of the aerial photo-imaging position AP21. For example, the terminal control unit 81 may extract aerial photo-imaging lines that pass through the inadequate area LA. Here, any of the aerial photo-imaging lines c1 through c4 passes through a portion of the inadequate area LA. Accordingly, the terminal control unit 81 may generate and configure an aerial photo-imaging position AP21 to be placed inside of the inadequate area LA and/or to be near the aerial photo-imaging position AP11. Accordingly also, the terminal 80 improves the repeatability OV1 of the aerial photo-imaging lines c1 through c4, and is able to provide user-desirable repeatability OV1 on the aerial photo-imaging lines c1 and c2.

Thereafter, the terminal control unit 81 may calculate repeatability (OV2) at each position inside of the aerial photo-imaging range A1. The terminal control unit 81 then calculate repeatability OV2 of photo-imaging by cameral 220 or cameral 230 of the unmanned aerial vehicle 100 at the aerial photo-imaging position AP11 and the aerial photo-imaging position AP21. In comparison to photo-imaging only at the aerial photo-imaging position AP11, photo-imaging at the aerial photo-imaging positions AP11 and AP21 results in less areas of which repeatability OV2 is below the threshold th, or number or size of the inadequate areas LA is decreased. Repeatability OV2 is an example of the second repeatability.

When photo-imaging is performed at the aerial photo-imaging positions AP11 and AP21, and when positions or inadequate area LA remain with repeatability OV2 below the threshold th, additional aerial photo-imaging positions AP21 may be generated and configured by the terminal control unit 81. The terminal control unit 81 may configure additional aerial photo-imaging positions AP21 according to the location of the inadequate area LA. For example, additional aerial photo-imaging positions AP21 may be placed external to the existing aerial photo-imaging positions AP21 that are located inside of or near the inadequate area LA. Existence of the aerial photo-imaging position AP21 on the aerial photo-imaging lines c1 and c2 results in a repeatability greater than the threshold th, and therefore, more aerial photo-imaging positions AP21 may be added onto the aerial photo-imaging lines c1 and c2.

Thereafter, the terminal control unit 81 calculates the repeatability OV2 at each position inside of the aerial photo-imaging range A1. Under these circumstances, the terminal control unit 81 calculates the repeatability OV2 of photo-imaging performed by the camera 220 or the camera 230 of the unmanned aerial vehicle 100 at the aerial photo-imaging position AP11 and the aerial photo-imaging position AP21. Accordingly, when positions or inadequate areas LA remain with repeatability OV2 below the threshold th, the terminal control unit 81 may continue with addition of the aerial photo-imaging positions AP21, with calculation of the repeatability OV2, and with determination of extent of the inadequate areas LA remaining, until the inadequate area LA becomes not detectable.

Accordingly, by reducing or eliminating existence of aerial photo-imaging lines of which repeatability OV (OV1 and OV2) is below the threshold th, the terminal 80 helps obtain certain user-desirable repeatability OV, such that inadequate area LA becomes undetectable in the entire aerial photo-imaging range A1.

Accordingly, the terminal 80 may generate aerial photo-imaging positions AP21 according to the location of the inadequate area LA, and configure aerial photo-imaging positions AP21 in locations near the inadequate area LA. In so doing, the terminal 80 improves on deficient repeatability OV of the inadequate area LA.

Moreover, and via the aerial photo-imaging lines that pass through the inadequate area LA, the terminal 80 generates aerial photo-imaging AP21 at a location external to the aerial photo-imaging positions AP11 which are in turn located at ends of the inadequate area LA on the aerial photo-imaging line, and thus improves on repeatability at the peripheral of the aerial photo-imaging range A1. Accordingly, repeatability OV may be improved at areas such as areas peripheral to the aerial photo-imaging range A1 that are more susceptible to insufficient repeatability. Moreover, the terminal 80 does not necessarily need to conduct photo-imaging in areas where sufficient repeatability has been obtained, and therefore number of photographic images that need to be taken may be decreased, and efficiencies in increasing repeatability may be improved.

When there are positions at which repeatability OV2 is below the threshold th, the terminal 80 supplements aerial photo-imaging positions AP21, such that in cases where improvement on repeatability OV1 with the initial supplement of aerial photo-imaging positions AP21 may not be sufficient, further improvement on repeatability with this additional supplement may be anticipated. Accordingly, additional aerial photo-imaging positions AP21 may be supplemented until user-desirable repeatability OV2 is achieved, at which point the inadequate area LA that otherwise indicates insufficient repeatability OV2 becomes undetectable.

The terminal 81 generates an aerial photo-imaging route AP22 that passes through the aerial photo-imaging position AP11 and the aerial photo-imaging position AP21 configured according to methods described herein. For example, aerial photo-imaging lines that contain the aerial photo-imaging position AP11 or aerial photo-imaging position AP21 may be connected in turn to generate the aerial photo-imaging route AP22. For example, the aerial photo-imaging positions AP11 or AP21 that are located at end portions of the aerial photo-imaging route may be connected together to form the aerial photo-imaging route AP22. Formation of the aerial photo-imaging route AP22 is not limited, for example, any of the aerial photo-imaging positions AP11 and AP21 may be connected to form the aerial photo-imaging route AP22. The aerial photo-imaging route is not necessarily of the shortest distance connecting the aerial photo-imaging positions AP11 and AP21 as long as repeatability greater than threshold th is achieved within the aerial photo-imaging range A1. The aerial photo-imaging route AP22 is an example route of the second photo-imaging route.

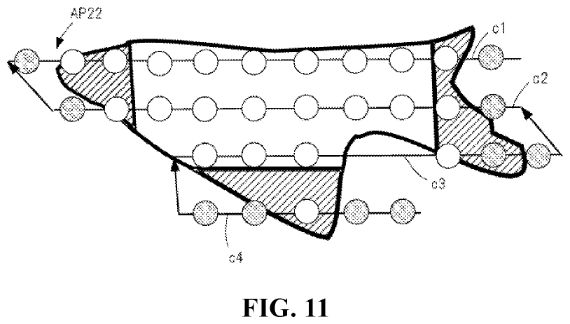

FIG. 11 is a schematic diagram showing the aerial photo-imaging route AP22 that passes the aerial photo-imaging positions AP11 and AP21. In FIG. 10, the aerial photo-imaging route AP22 is generated in a way where the route AP22 starts from a right end of the aerial photo-imaging line c4, travels to a left end of the aerial photo-imaging line c4, then travels to a left end of the aerial photo-imaging line c3, then travels to a right end of the aerial photo-imaging line c3, then travels to a right end of the aerial photo-imaging line c2, then to a left end of the aerial photo-imaging line c2, then to a left end of the aerial photo-imaging line c1, and eventually arrives at a right end of the aerial photo-imaging line c1.

Next, action steps are described in relation to the aerial photo-imaging route generation system 10.

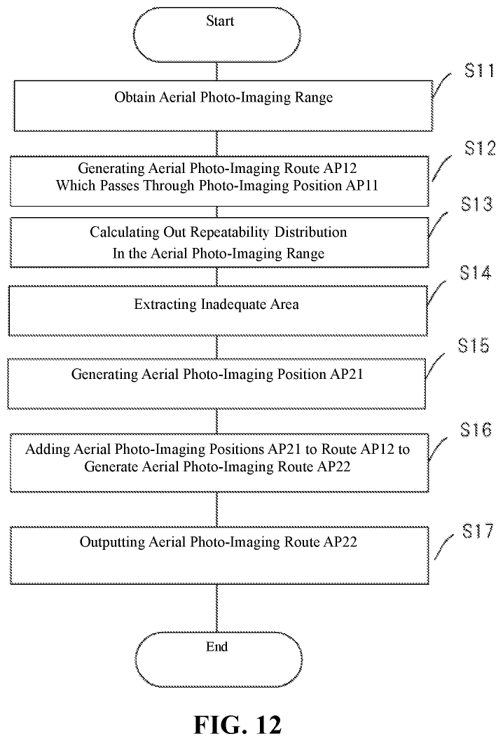

In this example embodiment, the terminal 80 executes the action steps associated with generating the aerial photo-imaging route. FIG. 12 is a schematic block diagram showing action steps at the terminal 80.

At step S11, the terminal control unit 81 obtains aerial photo-imaging range A1. The terminal control unit 81 generates the aerial photo-imaging route AP12 that passes through the aerial photo-imaging position AP11 contained within the aerial photo-imaging range A1. The terminal control unit 81 calculates repeatability OV at each position, such as the aerial photo-imaging position AP11, during photo-imaging by the camera unit 220 or the camera unit 230 of the unmanned aerial vehicle 100. At step S13, the terminal control unit 81 calculates the repeatability distribution at each position within the aerial photo-imaging range A1.

At step S14, the terminal control unit 81 extracts the inadequate area LA according to repeatability OV at each position contained within the aerial photo-imaging range A1. The terminal control unit 81 generates and configures the aerial photo-imaging position AP21 according to the inadequate area LA. Via the use of aerial photo-imaging position AP21, otherwise insufficient repeatability associated with photo-imaging at aerial photo-imaging position AP11 alone may be improved on. At step S16, the terminal control unit 81 supplements aerial photo-imaging positions AP21 onto the aerial photo-imaging route AP12, to form aerial photo-imaging route AP22. The terminal 81 thus forms the aerial photo-imaging route AP22 that passes through the aerial photo-imaging positions AP11 and AP21.

At step S17, the terminal control unit 81 outputs information on the aerial photo-imaging positions AP11 and AP21 and the aerial photo-imaging route AP22. For example, the terminal control unit 81 may send to the unmanned aerial vehicle 100 information on the aerial photo-imaging positions AP11 and AP21 and the aerial photo-imaging route AP22 via the communication unit 85. The terminal control unit 81 may store, into an external recording device such as a SD card as the storage unit 89, information on the aerial photo-imaging positions AP11 and AP21 and the aerial photo-imaging route AP22.

Within the unmanned aerial vehicle 100, the UAV control unit 110 obtains information outputted from the terminal 80, the information being on the aerial photo-imaging positions AP11 and AP21, and aerial photo-imaging route AP22. For example, the UAV control unit 110 may receive information on aerial photo-imaging positions AP11 and AP21 and aerial photo-imaging route AP22 via the communication interface 150. The UAV control unit 110 may obtain information on the aerial photo-imaging positions AP11 and AP21 and the aerial photo-imaging route AP22 via external recording devices. The UAV control unit 110 sets forth the aerial photo-imaging positions AP11 and AP21 and aerial photo-imaging route AP22 as obtained. The UAV control unit 110 stores in the memory 160 information on the aerial photo-imaging positions AP11 and AP21 and the aerial photo-imaging route AP22, and is further configured to control flying status through the UAV control unit 110 using the information on the aerial photo-imaging positions AP11 and AP21 and the aerial photo-imaging route AP22. Accordingly, the unmanned aerial vehicle 100 may fly along the aerial photo-imaging route AP22 generated by the terminal 80, and forms aerial photographic images at aerial photo-imaging positions AP11 and AP21. These aerial photographic images may be used to form a composite image or a stereoscopic image within the aerial photo-imaging range A1.

According to these example actions, and when insufficient repeatability is found at any position within the aerial photo-imaging range A1, the terminal may alleviate or cure such insufficiency via configuring aerial photo-imaging positions AP21. The terminal 80 may increase number of repeats for the multiple image range GH, and to ascertain certain level of repeatability OV. Although insufficient repeatability OV may occur at a peripheral portion of the aerial photo-imaging range A1, such insufficiency in repeatability OV is alleviated or cured by the terminal 80. Accordingly, the terminal may reduce decrease in image quality of a resultant composite image or a stereoscopic image formed from multiple aerial photographic images.

The terminal 80 does not need to preset an area that is bigger than the aerial photo-imaging range A1 to be targeted for aerial photo-imaging or for generating aerial photo-imaging routes, and rather is able to flexibly adjust via configuring aerial photo-imaging positions AP21 accordingly to the sufficiency level of repeatability. In comparison to a method of generally presetting an area bigger than the aerial photo-imaging area A1, possibility of the terminal 80 in configuring useless aerial photo-imaging positions AP21 is relatively low, while certain level of photo-imaging efficiency and repeatability OV may be maintained.

The terminal 80 may send to the unmanned aerial vehicle 100 information on the aerial photo-imaging positions AP11 and AP21, and information on aerial photo-imaging route AP22, and configure on the unmanned aerial vehicle 100 presence of the aerial photo-imaging positions AP11 and AP21, and aerial photo-imaging route AP 22.

Per this disclosure, the aerial photo-imaging route may be generated via the unmanned aerial vehicle 100. Under this arrangement, the UAV control unit 110 of the unmanned aerial vehicle 100 is of same function in generating aerial photo-imaging routes as the terminal control unit 81 of the terminal 80. The UAV control unit 110 is an example of the processing unit. The UAV control unit 110 conducts processes related to generation of aerial photo-imaging routes. In addition, and during the process related to generation of aerial photo-imaging routes by the UAV control unit 110, processes related to generation of aerial photo-imaging routes via interaction with the terminal control unit 81 may be abbreviated or minimized.

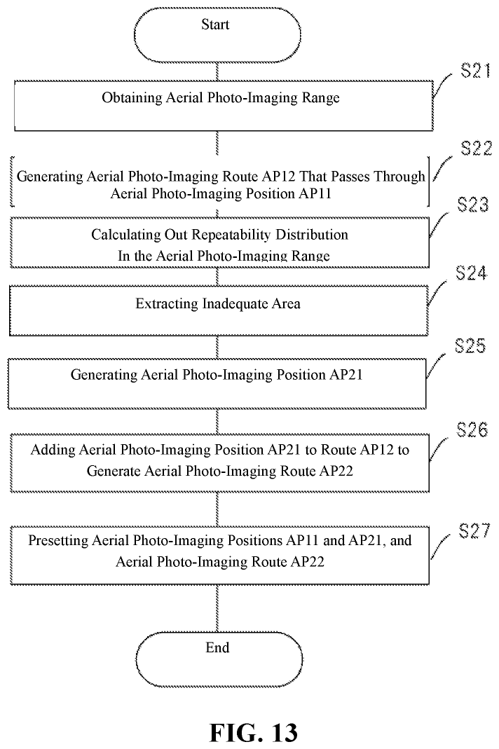

FIG. 13 is a schematic flow chart diagram showing example actions of the unmanned aerial vehicle 100.

At step S21, the UAV control unit 110 obtains the aerial photo-imaging area A1. At step S22, the UAV control unit 110 generates the aerial photo-imaging route AP12 that passes through the aerial photo-imaging position AP11 contained within the aerial photo-imaging range A1 and at which photo-imaging is conducted. The UAV control unit 110 calculates repeatability at each position such as the aerial photo-imaging position AP11 during photo-imaging by the camera unit 220 or the camera unit 230 of the unmanned aerial vehicle 100. In other words, and at step S23, the UAV control unit 110 calculates repeatability distribution as each position contained within the aerial photo-imaging range A1.

At step S24, the UAV control unit 110 extracts the inadequate area LA according to the repeatability OV at each position within the aerial photo-imaging range A1. At step S25, the UAV control unit 110 generates and configures aerial photo-imaging position AP21 according to the inadequate area LA. Through the aerial photo-imaging position AP21, otherwise insufficient repeatability associated with photo-imaging only at photo-imaging positions AP11 may be improved. At step S26, the UAV control unit 110 adds the aerial photo-imaging position AP21 onto the aerial photo-imaging route AP12 and generates the aerial photo-imaging route AP22. In other words, the UAV control unit 110 generates the aerial photo-imaging route AP22 that passes through the aerial photo-imaging positions AP11 and AP21.

At step S27, the UAV control unit 110 forms the aerial photo-imaging positions AP11 and AP21, and the aerial photo-imaging route AP22. Under these circumstances, the UAV control unit 110 stores in the memory 160 information on the aerial photo-imaging positions AP11 and AP21, and the aerial photo-imaging route AP22. Information on the aerial photo-imaging positions AP11 and AP21, and the aerial photo-imaging route AP22 may be used to control flying status via the UAV control unit 110. Accordingly, the unmanned aerial vehicle 100 may fly along the aerial photo-imaging route AP22 generated by the unmanned aerial vehicle 100, and may capture aerial photographic images at the aerial photo-imaging positions AP11 and AP21. The aerial photographic images may be used to form composite images or stereoscopic images within the aerial photo-imaging range A1.

According to such an example flow of actions, when a position is found in the aerial photo-imaging range A1 to be of insufficient repeatability, the unmanned aerial vehicle 100 may alleviate the insufficiency of repeatability via configuring aerial photo-imaging positions AP21, to achieve repeatability OV of a certain level. Even though insufficient repeatability is likely to result in the peripheral portions of the aerial photo-imaging range A1, such insufficiency may be alleviated or overcome by the unmanned aerial vehicle 100. Therefore, the unmanned aerial vehicle 100 helps reduce decrease in image quality of a composite image or a stereoscopic image formed via multiple aerial photographic images.

The unmanned aerial vehicle 100 does not need to preset an area that is bigger than the aerial photo-imaging range A1 to be targeted for aerial photo-imaging or for generating aerial photo-imaging routes, and rather is able to flexibly adjust via configuring aerial photo-imaging positions AP21 accordingly to the sufficiency level of repeatability. In comparison to a method of generally presetting an area bigger than the aerial photo-imaging area A1, possibility of the unmanned aerial vehicle 100 in configuring useless aerial photo-imaging positions AP21 is relatively low, while certain level of photo-imaging efficiency and repeatability OV may be maintained.

The unmanned aerial vehicle 100 may configure aerial photo-imaging positions AP11 and AP21, and aerial photo-imaging route AP22, may fly along the aerial photo-imaging route AP22, and may capture photographic images at aerial photo-imaging positions AP11 and AP21. The unmanned aerial vehicle 100 is thus able to improve on process accuracy of an aerial photographic image, for example, in generating a composite image or a stereoscopic image, and able to improve on image quality of thus obtained images.

When the unmanned aerial vehicle 100 generates the aerial photo-imaging route, the terminal control unit 81 at the terminal 80 may process to help generate the aerial photo-imaging route, for example via operations by the operation unit 83 and via displays by the display unit 88 at the terminal 80. The UAV control unit 110 of the unmanned aerial vehicle 100 may send, via the communication interface 150, to the terminal 80 information of repeatability at each position within the aerial photo-imaging range A1 according to the repeatability distribution map OM. The terminal control unit 81 may obtain information from the unmanned aerial vehicle 100 via the communication unit 85, and display the repeatability distribution map OM on the display unit 88.

The user may ascertain the repeatability distribution map OM as displayed via the display unit 88, while configuring aerial photo-imaging positions AP21 at locations of insufficient repeatability, such as locations in or near the inadequate area LA via input through the operation unit 83 at the terminal 80. Accordingly, generation of aerial photo-imaging routes by the unmanned aerial vehicle 100 is assisted via input and display operations at the terminal 80.

In the disclosure, aerial photographic images may be captured by the unmanned aerial vehicle 100, and also may be captured by moving objects other than the unmanned aerial vehicle 100, such as vehicles. This disclosure may be used to generate aerial photo-imaging routes via the use of such movable objects.

The disclosure is described in view of the embodiments, but technical scope of the disclosure is not limited to the contents represented by the embodiments. To those skilled in the technical art, many suitable changes and improvements may be made to the example embodiments. Such suitable changes and improvements are understood to be included in the scope defined by the claims.

Devices, systems, programs, and methods in actions, orders, steps, and periods as described or shown in the claims, the description, and the drawings, are not necessarily in any particular order and may be in any suitable order, as long as a previous output is not used in a later treatment, and except where “before” or “prior to” is expressly stated.

In describing steps related to the claims, the description, and the drawings, the term such as “first” and “next” may be used to simplify the task of description, but not to imply such order is necessary.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A movable platform to generate a photo-imaging route using a movable object, the movable platform including a memory and a processor coupled to the memory, the processor being configured to perform:
obtaining information on a photo-imaging range;
generating a first photo-imaging route, the first photo-imaging route passing through a first photo-imaging position at which a first range of photographic images is captured within the photo-imaging range;
calculating a first repeatability of the first range of photographic images obtained at the first photo-imaging position;
when the first repeatability is below a threshold, generating a second photo-imaging position at which a second batch of photographic images is captured; and
generating a second photo-imaging route, the second photo-imaging route passing through both the first photo-imaging position and the second photo-imaging position.

2. The movable platform according to claim 1, wherein generating the second photo-imaging position includes:
when the first repeatability is below the threshold, identifying an inadequate area within the photo-imaging range, the inadequate area including the first photo-imaging position; and
generating the second photo-imaging position according to a location of the inadequate area within the photo-imaging area.

3. The movable platform according to claim 2, wherein the first photo-imaging route includes a plurality of photo-imaging lines, at least one of the plurality of photo-imaging lines passes through the inadequate area, and the at least one of the plurality of photo-imaging lines passes through the first photo-imaging position, and wherein generating the second photo-imaging position includes:
placing the second photo-imaging position to be aside from the first photo-imaging position and to be external to the inadequate area.

4. The movable platform according to claim 1, wherein the processor is further configured to perform:
calculating a second repeatability of the photo-imaging range obtained at the first photo-imaging position and the second photo-imaging position, wherein generating the second photo-imaging position includes:
generating an additional second photo-imaging position when the second repeatability is below the threshold.

5. The movable platform according to claim 1, wherein calculating the first repeatability calculating the first repeatability according to a movement parameter and a photo-imaging parameter of the movable object at the first photo-imaging position.

6. The movable platform according to claim 1, wherein the movable object is a terminal, and wherein the processor is further configured to perform:
sending to the movable object information on the first photo-imaging position, the second photo-imaging position, and the second photo-imaging route.

7. The movable platform according to claim 1, wherein the processor is further configured to perform:
generating a map showing distribution of the first repeatability at each of positions contained within the photo-imaging range; and
displaying the map.

8. The movable platform according to claim 1, wherein the processor is further configured to perform:
presetting the first photo-imaging position, the second photo-imaging position, and the second photo-imaging route.

9. The movable platform according to claim 1, wherein the movable object includes a flying object, and wherein the photographic images include photographic images obtained via aerial photo-imaging.

10. A method of generating photo-imaging route to be used on a movable platform via a movable object, the method comprising:
obtaining information on a photo-imaging range;
generating a first photo-imaging route, the first photo-imaging route passing through a first photo-imaging position at which a first range of photographic images is captured within the photo-imaging range;
calculating a first repeatability of the first range of photographic images obtained at the first photo-imaging position;
when the first repeatability is below a threshold, generating a second photo-imaging position at which a second batch of photographic images is captured; and
generating a second photo-imaging route, the second photo-imaging route passing through both the first photo-imaging position and the second photo-imaging position.

11. The method according to claim 10, wherein generating the second photo-imaging position includes:
when the first repeatability is below the threshold, identifying an inadequate area within the photo-imaging range, the inadequate area including the first photo-imaging position; and
generating the second photo-imaging position according to a location of the inadequate area within the photo-imaging range.

12. The method according to claim 11, wherein the first photo-imaging route includes a plurality of photo-imaging area, at least one of the plurality of photo-imaging lines passes through the inadequate line, and the at least one of the plurality of photo-imaging lines passes through the first photo-imaging position, and wherein generating the second photo-imaging position includes:
placing the second photo-imaging position to be aside from the first photo-imaging position and to be external to the inadequate area.

13. The method according to claim 10, further comprising:
calculating a second repeatability of the photo-imaging range obtained at the first photo-imaging position and the second photo-imaging position, wherein generating the second photo-imaging position includes:
generating an additional second photo-imaging position when the second repeatability is below the threshold.

14. The method according to claim 10, wherein calculating the first repeatability includes calculating the first repeatability according to a movement parameter and a photo-imaging parameter of the movable object at the first photo-imaging position.

15. The method according to claim 10, wherein the movable object is a terminal, the method further comprising:
sending to the movable object information on the first photo-imaging position, the second photo-imaging position, and the second photo-imaging route.

16. The method according to claim 10, wherein the movable platform is a terminal, the method further comprising:
generating a map showing distribution of the first repeatability at each of positions contained within the photo-imaging range; and
displaying the map.

17. The method according to claim 10, wherein the movable platform is the movable object, the method further comprising:
presetting the first photo-imaging position, the second photo-imaging position, and the second photo-imaging route.

18. The method according to claim 10, wherein the movable object includes a flying object, and wherein the photographic images include photographic images obtained via aerial photo-imaging.

19. The method according to claim 10, wherein the first photo-imaging positions includes first-one and first-two photo-imaging positions and the second photo-imaging positions include second-one and second-two photo-imaging positions, and the second photo-imaging route connects in an order of the second-one photo-imaging position, the first-one photo-imaging position, the second-two photo-imaging position, and the first-two photo-imaging position.

20. The movable platform according to claim 1, wherein the first photo-imaging positions includes first-one and first-two photo-imaging positions and the second photo-imaging positions include second-one and second-two photo-imaging positions, and the second photo-imaging route connects in an order of the second-one photo-imaging position, the first-one photo-imaging position, the second-two photo-imaging position, and the first-two photo-imaging position.
